(19) United States
(12) Patent Application Publication
(10) Pub. No.: US 2019/0051132 A1
(43) Pub. Date: Feb. 14, 2019

(54) MONITORING SYSTEM AND METHOD OF USE

(71) Applicant: Tamara Shepard, Irving, TX (US)

(72) Inventor: Tamara Shepard, Irving, TX (US)

(21) Appl. No.: 16/101,004

(22) Filed: Aug. 10, 2018

Related U.S. Application Data
(60) Provisional application No. 62/544,137, filed on Aug. 11, 2017.

(51) Int. Cl. G08B 21/02; G07C 9/00; A01K 27/00

(52) U.S. Cl. CPC G08B 21/0288; G07C 9/00722; A01K 27/001; G08B 21/0263; G08B 21/0233; G08B 21/0208; G08B 21/0275; G08B 21/0269

(57) ABSTRACT

A monitoring system for allowing a guardian to monitor a keeper, the monitoring system a guardian unit to be worn by the guardian, the guardian unit has a power source; and a transceiver; a key incorporated into the guardian unit; a band to be worn by the keeper, the band having a GPS unit; a lock to release the band from the keeper; a power source; and a control system having a transceiver to wirelessly communicate with the transceiver of the guardian unit; the lock is to unlock through communication with the key of the guardian unit; a network, having a computing device; and a platform accessible from the computing device; the platform is to allow the guardian to monitor activity associated with the keeper via data received by the control system of the band.

### BACKGROUND

### 1. Field of the Invention

The present invention relates generally to child monitoring systems, and more specifically, to a monitoring system for a guardian to receive updates regarding the location and safety of a child, pet, disabled, elderly, or anyone else that the guardian wishes to monitor.

### 2. Description of Related Art

Child monitoring systems are well known in the art and are effective means to keep track of children. For example, FIG. 1 depicts a conventional monitoring system 101 having GPS tracking band 103 secured to a child 105. During use, the band 103 communicates through a network 107 to send location information to a computing device 109.

One of the problems commonly associated with system 101 is the ability of band 103 to be removed easily or damaged. For example, a child can easily remove the band and therefore tracking information is no longer sent to computing device 109. In addition, the band may break or become damages, thereby being ineffective to send information to device 109.

Accordingly, although great strides have been made in the area of child monitoring systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a common child monitoring system;

FIG. 2 is a simplified schematic of a child monitoring system in accordance with a preferred embodiment of the present application;

FIG. 3 is a simplified view of a first embodiment of the band of FIG. 2;

FIG. 4 is a simplified view of a second embodiment of the band of FIG. 2;

FIG. 5 is a simplified schematic of a child monitoring system in accordance with an alternative embodiment of the present application; and

FIG. 6 is a flowchart of the method of use of FIG. 2.

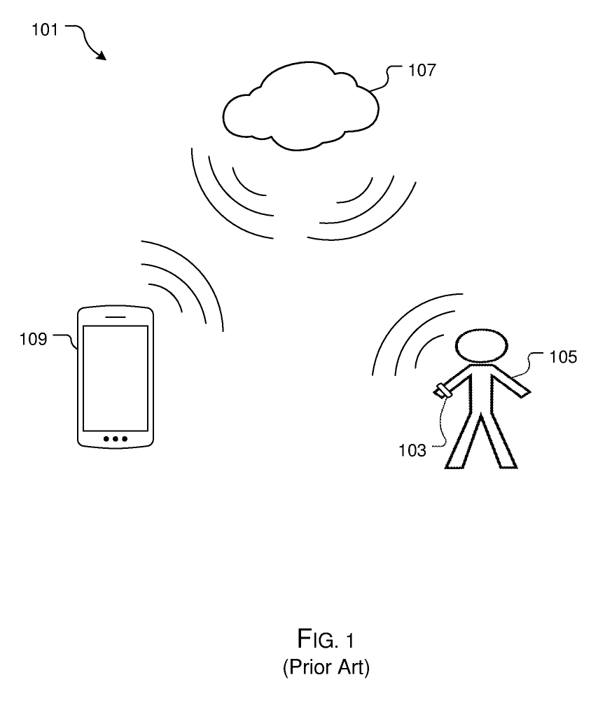

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional child monitoring systems. Specifically, the present invention provides a means to reduce the possibility of a tracking band becoming damaged or removed from a child. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

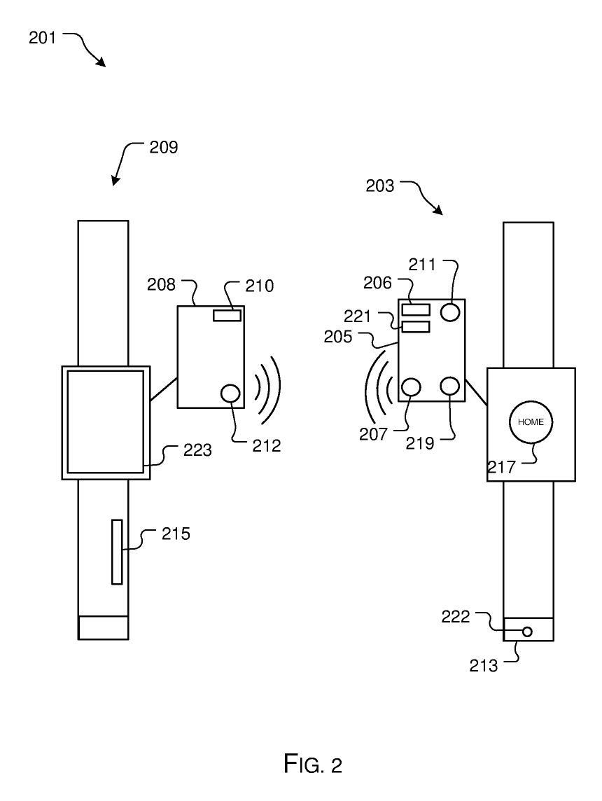

Referring now to the drawings wherein like reference characters identify corresponding or similar elements throughout the several views, FIG. 2 depicts a simplified schematic of a monitoring system 201 in accordance with a preferred embodiment of the present application. It will be appreciated that system 201 overcomes one or more of the above-listed problems commonly associated with conventional child monitoring systems.

In the contemplated embodiment, system 201 includes a first band 203 configured to be associated with a keeper. It should be understood that keeper can mean any being that a guardian wishes to monitor. For example, system 201 can be associated with a parent and child, an owner and pet, a guardian and an elderly person, or any other relationship in which one person wishes to monitor another being.

Band 203 includes a control system 205 having at least a power source 206 and a transceiver 207 configured to allow band 203 to wirelessly communicate with a guardian unit 209 having a control system 208 with a power source 210 and a transceiver 212. In this embodiment, guardian unit 209 is shown as a second band, however, it should be appreciated that guardian unit 209 can be a handheld unit, or other device.

Band 203 further includes a GPS 211 which provides location information to control system 205 to allow the control system to communicate the location to a guardian. It should be appreciated that this feature allows for system 201 to be used to monitor and track the location of the keeper.

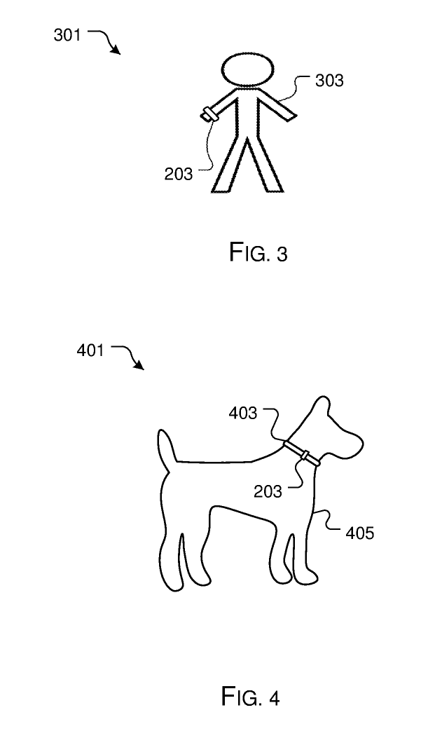

Band 203 further includes a lock 213 configured to secure the band to the keeper. As shown in FIGS. 3 and 4, in one embodiment 301, the band 203 is configured to secure to a wrist of a child 303. In another contemplated embodiment 401, the band 203 is configured to secure to a collar 403 or a pet 405. It should be appreciated that the size and aesthetical features of the band can vary.

It should be appreciated that one of the unique features believed characteristic of the present application is lock 213. Lock 213 is configured to be associated with a key 215 of guardian unit 209. Once secured, lock 213 remains locked until coming into close proximity with key 215. In one contemplated embodiment, key 215 is a magnetic key configured to magnetically communicate with an internal mechanism of lock 213 to unlock lock 213 upon coming into close proximity. It is contemplated that other electronic locks and keys could be used.

In some embodiments, band 203 can include additional features. Band 203 can include a home button 217 configured to send an alert to unit 209. In addition, band 203 can include one or more speakers 219 configured to provide audio alerts upon the pressing of button 217, thereby causing an alarm to be activated in the event that the keeper becomes endangered. Band 203 can further include a camera 221 configured to take and transmit images to parental unit 209. In some embodiments, lock 213 can include an emergency release button 222 configured to release lock 213 without a key. However, it should be appreciated that emergency release button 222 will be configured to cause control system 205 to transmit an emergency signal to guardian unit 209.

In one embodiment, as shown in FIG. 2, parental unit 209 includes a digital display 223 configured to provide updates to the guardian.

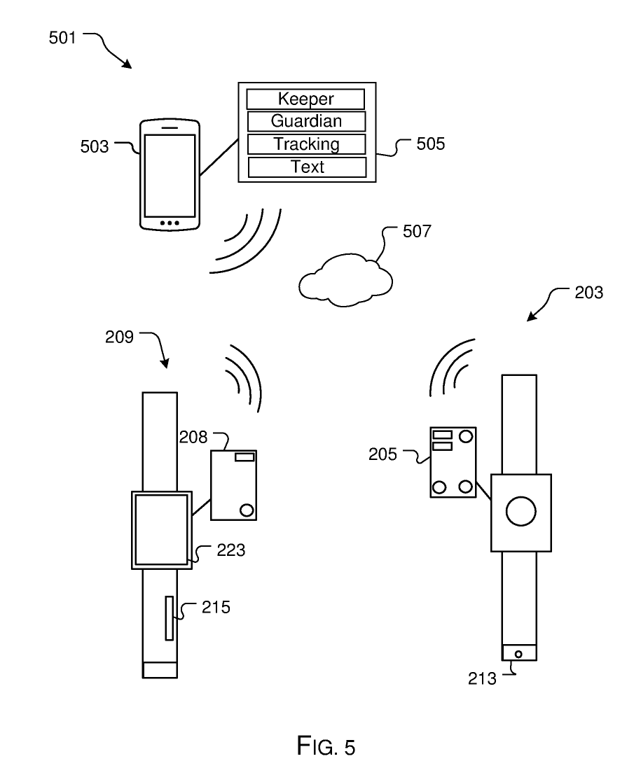

As shown in FIG. 5, in an alternative embodiment of a monitoring system 501, a computing device 503, such as a mobile phone, provides access to a platform 505. Platform 505 can be a mobile application configured to track and record data associated with the monitoring of a keeper. In this embodiment, the band 203, guardian unit 209, and computing device 503 all communicate wirelessly though a network 507.

In system 501, platform 505 can include various features, such as a means to input keeper information, such as health and physical data. In addition, platform 505 can include a profile development portal for the guardian to input personal info to create a profile. In addition, platform 505 can track and record data associated with system 505 an be configured to send text updates to the guardian.

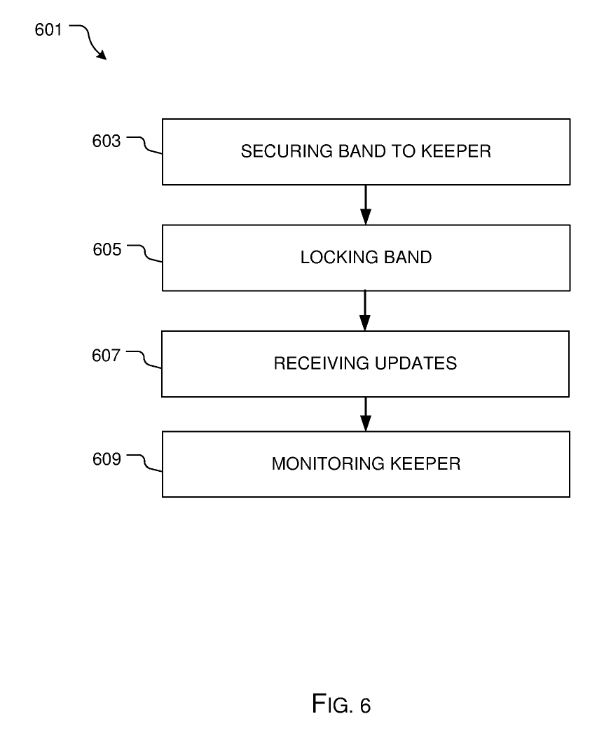

In FIG. 6, a flowchart 601 depicts a method of use associated with system 201 and 501. The band is secured to a keeper, such as a child or pet, and locked in place via the lock, as shown with boxes 603, 605. The guardian then receives updates wither through the guardian unit or computing device or both, as shown with box 607. The guardian can the monitor the location of the keeper, as shown with box 609. When the band needs to be removed, the guardian can unlock the band with use of the key built into the guardian device, as shown with box 609.

It is contemplated that additional accessories can be used with system 201 for providing additional means of keeping track of the location of the keeper. For example, it is contemplated that accessories such as shoe laces, jewelry, belts, and/or buttons could be used with GPS devices to transmit location information, thereby allowing for the location of the keeper to be checked with multiple GPS units.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A monitoring system for allowing a guardian to monitor a keeper, the monitoring system comprising:
a guardian unit configured to be worn by the guardian, the guardian unit having:
a power source; and
a transceiver;
a key incorporated into the guardian unit;
a band configured to be worn by the keeper, the band having:
a GPS unit;
a lock configured to release the band from the keeper;
a power source; and
a control system having a transceiver configured to wirelessly communicate with the transceiver of the guardian unit;
wherein the lock is configured to unlock through communication with the key of the guardian unit;
a network, having:
a computing device; and
a platform accessible from the computing device;
wherein the platform is configured to allow the guardian to monitor activity associated with the keeper via data received by the control system of the band.

2. The system of claim 1, wherein the guardian unit is a second band configured to be worn by the guardian.

3. The system of claim 1, wherein the guardian unit and the computing device are combined into one device.

4. The system of claim 1, wherein the guardian unit further comprises:
a display configured to provide a visual representation of the data.

5. The system of claim 1, wherein the band further comprises:
a home button;
wherein activation of the home button sends an alert to the guardian unit.

6. The system of claim 1, wherein the key is a magnetic key configured to unlock the lock through magnetic communication.

7. The system of claim 1, wherein the band further comprises:
a speaker; and
an alert incorporated into the control system;
wherein the alert is programed to signal through the speaker upon set criterion.

8. The system of claim 7, wherein the set criterion is a predetermined distance between the band and computing device.

9. The system of claim 1, wherein the band is configured to secure to a wrist of a person.

10. The system of claim 1, wherein the band is configured to secure to a collar of a pet.

11. The system of claim 1, wherein the band further comprises:
a camera configured to take and record images into the control system; and
wherein the control system transmits the images to the computing device.

12. A method of monitoring a child given the system of claim 1;
securing the band to the child;
locking the band;
receiving updates regarding location of the child via the computing device and platform; and
monitoring the location via the platform.
